(19) United States
(12) Patent Application Publication
(10) Pub. No.: US 2006/0038451 A1
(43) Pub. Date: Feb. 23, 2006

(54) Small-power electric motor

(75) Inventor: Carsten Lang, Schluchsee (DE)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/186,998

(22) Filed: Jul. 22, 2005

(30) Foreign Application Priority Data
Jul. 31, 2004 (DE) 202004012027.5

(51) Int. Cl. H02K 11/00; H01R 39/38

(52) U.S. Cl. 310/68 B; 310/239

(57) ABSTRACT

A small-power electric motor comprising a stationary part and a part which rotates about a shaft, wherein the stationary part has a brush plate with a number of brushes and at least one magnetic field sensor, and wherein the rotating part has collector surfaces assigned to the brushes and at least one sensor magnet assigned to the magnetic field sensor.

### BACKGROUND OF THE INVENTION

The invention is based on the priority of German Utility Model 202004012027.5 which is hereby incorporated by reference.

The invention relates to a small-power electric motor comprising a stationary part and a part which rotates about a shaft, wherein the stationary part has a brush plate comprising a number of brushes and at least one magnetic field sensor, and wherein the rotating part has collector surfaces assigned to the brushes and at least one sensor magnet assigned to the magnetic field sensor.

Such motors are already on the market. In the case of these known motors, the sensor unit, which consists of a magnetic field sensor and a sensor magnet, is accommodated beneath an additional cover outside the actual motor housing.

The motor consequently becomes not only larger, but also disproportionately more expensive. In addition, there are further problems to be solved, depending on the protection class of the motor.

### SUMMARY OF THE INVENTION

The invention is based on the object of remedying this situation.

This object is achieved by a small-power electric motor comprising a stationary part and a part which rotates about a shaft, wherein the stationary part has a brush plate comprising a number of brushes and at least one magnetic field sensor, and wherein the rotating part has collector surfaces assigned to the brushes and at least one sensor magnet assigned to the magnetic field sensor, and wherein at least one magnetic field sensor is disposed on the brush plate.

In this case, the magnetic field sensor is concomitantly disposed on the brush plate, and therefore requires practically no additional space. The associated sensor magnet can usually be mounted relatively easily on the rotor. If a plurality of magnetic field sensors or sensor magnets are required, this does not present any problem.

Further developments of the invention are disclosed by the sub-claims and the following description.

### BRIEF DESCRIPTION OF THE DRAWINGS

The invention is explained more fully in the following with reference to the accompanying drawings, wherein:

FIG. 1 shows a section through the small-power electric motor according to the invention.

FIG. 2 shows the brush plate of the small-power electric motor according to FIG. 1.

### DETAILED DESCRIPTION OF THE DRAWINGS

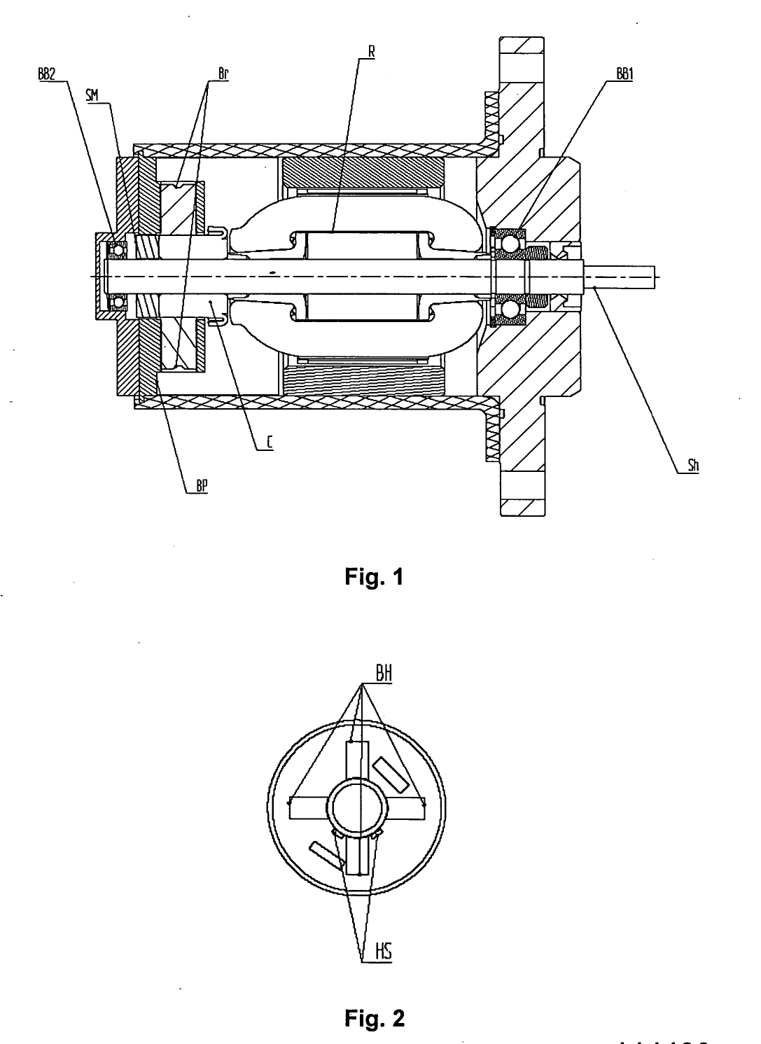

FIG. 1 shows a section through a small-power electric motor, in which there are represented those parts that are necessary for understanding of the present invention.

In respect of rotating parts, FIG. 1 shows a shaft Sh, a rotor R, a collector C and a sensor magnet SM.

In respect of stationary parts, the figure shows a brush plate BP and two brushes Br attached thereto.

The rotating and the stationary parts are interconnected via two ball bearings BB1 and BB2.

The brush plate BP is represented separately in FIG. 2 which, in this view, shows two Hall sensors HS as magnetic field sensors.

Since the magnetic field sensor is disposed on the brush plate, it is possible to dispense with a separate component mount for said magnetic field sensor.

It is usually still structurally possible for the magnetic field sensor to be disposed on the same side of the brush plate as the brushes themselves. Consequently, the magnetic field sensor does not require any additional space.

Obviously, the sensor magnet SM must in any case be so disposed that it is able to influence the magnetic field sensor HS.

A very compact structure is obtained if the motor housing has a respective ball bearing BB1 and BB2 at both ends and, in particular, if the brush plate BP, the collector C, the magnetic field sensor HS and the sensor magnet SM are disposed between the ball bearings.

The same obviously applies accordingly if there is not just one sensor magnet, or there are not two magnetic field sensors.

The use of other magnetic field sensors, based on a physical phenomenon other than the Hall effect, for instance an induction-effect-based coil, is obviously not precluded.

1. Small-power electric motor comprising a stationary part and a part which rotates about a shaft, wherein the stationary part has a brush plate comprising a number of brushes and at least one magnetic field sensor, wherein the rotating part has collector surfaces assigned to the brushes and at least one sensor magnet assigned to the magnetic field sensor, and wherein at least one magnetic field sensor is disposed on the brush plate.

2. Small-power electric motor according to claim 1, characterized in that at least one magnetic field sensor is disposed on the same side of the brush plate as the brushes.

3. Small-power electric motor according to claim 1, characterized in that two ball bearings are disposed between the stationary and the rotating part, characterized in that the brush plate, the collector, the at least one magnetic field sensor and the at least one sensor magnet are disposed between the two ball bearings.
